(19) United States
(12) Patent Application Publication
(10) Pub. No.: US 2007/0153839 A1
(43) Pub. Date: Jul. 5, 2007

(54) Single frequency thulium waveguide laser, an article comprising it, its use and a method of its manufacture

(75) Inventors: Poul Varming, Copenhagen (DK); Soren Agger, Soborg (DK)

Correspondence Address: BUCHANAN, INGERSOLL & ROONEY PC, POST OFFICE BOX 1404, ALEXANDRIA, VA, 22313-1404, US

(73) Assignee: KOHERAS A/S, Birkerod (DK)

(21) Appl. No.: 10/582,357

(22) PCT Filed: Dec. 13, 2004
(86) PCT No.: PCT/EP04/53433

§ 371 Date: Jun. 9, 2006

Related U.S. Application Data
(60) Provisional application No. 60/528,722, filed on Dec. 12, 2003.

(30) Foreign Application Priority Data
Dec. 11, 2003 (DK) PA 2003 01835

(51) Int. Cl. H01S 3/30; H01S 3/091; H01S 3/08

(52) U.S. Cl. 372/6; 372/106; 372/70

(57) ABSTRACT

The invention relates to an optical waveguide laser comprising a) an active region formed over a length of the optical waveguide, comprising an excitable material emitting light in response to stimulation by pump light thereby defining an optical gain profile and the excitable material comprises Tm; b) a frequency discriminated feedback element adapted to select a single longitudinal lasing mode by coordination with the frequency response of the optical gain of the excitable material; and c) a polarisation asymmetry element adapted for selecting a single polarisation mode of a given longitudinal mode by selectively suppressing propagation of the other polarisation mode of said longitudinal mode. The object of the present invention is to provide relatively simple, compact and economic lasers for single-frequency operation in the wavelength range of 1.7 um to 2.2 um; in particular for a number of applications, including spectroscopy and for eye-safe optical sources in sensing and in LIDAR, etc.

### TECHNICAL FIELD

The invention relates to an optical waveguide laser, an article comprising an optical waveguide laser, the use of an optical waveguide laser, and a method of manufacturing an optical waveguide laser.

In particular, the invention relates to a single-frequency waveguide laser with emission in the 1.7 μm to 2.2 μm wavelength band in general, and more particularly to such a laser for use as a light source, specifically for use as an absolutely calibrated laser light source in applications such as e.g. LIDAR, spectroscopy, sensor applications, frequency mixing, and for use in applications such as optical telecommunications, etc.

### BACKGROUND ART

Single-frequency laser sources operating in the wavelength band from 1.7 μm to 2.2 μm are desirable for various fields of application including industry, research, military, medical and biology. Specific applications in this wavelength range include eye-safe LIDAR (LIDAR being an abbreviation of Light Detection And Ranging) for measuring or mapping range, velocity, chemical composition and concentration, etc.; optical telecommunications; urban pollution monitoring; chemical process control; hazardous environment monitoring; atmospheric research; combustion research and development; automotive exhaust monitoring; volcanic activity monitoring; carbon cycle research; windshear; and wind speed.

Known LIDAR systems, however, are bulky, complex and expensive, and they have very limited wavelength tuning ranges. They typically use a neodymium-doped solid state laser operating at shorter near-infrared wavelengths, which can be transmitted through the eye and focussed onto the retina, requiring severe constraints in remote sensing applications due eye-safety considerations.

Various constructions of single-frequency lasers for emission in the 1.7 μm to 2.2 μm wavelength band are known.

Single-frequency lasers based on solid-state material waveguides with thulium (Tm) as the amplifying medium include Tm:YAG, Tm:LuAG and Tm,Ho:YLF lasers emitting in the 2.00 μm to 2.03 μm range. However, these waveguide lasers tend to be complex, expensive and to cover a narrow emission range (cf. e.g. the SPARCLE project of NASA & JPL in the US).

Semiconductor diode lasers enabling single frequency lasing and covering the entire mid-infrared wavelength region include InGaAsP/lnP lasers for emission in the 1.2 μm to 2.0 μm wavelength band, antimonide AlGaAsSb/-lnGaAsSb lasers for emission in the 2.0 μm to 2.7 μm wavelength band. For these lasers, single-frequency operation is obtained by using distributed feedback (DFB) and vertical cavity surface emitting laser (VCSEL) designs. Single-frequency lasing in the 3 μm to 20 μm wavelength band can be obtained by quantum cascaded DFB diode lasers.

Fibre ring lasers are very sensitive to environmental changes due to the long length of the laser resonator and as a consequence they tend to suffer from longitudinal mode-hops. DFB diode lasers with single-frequency emission at wavelengths longer than 1.7 μm are complex to fabricate, expensive and typically have a spectral linewidth between 1 MHz and 100 MHz. This is much higher than the typical 1-50 kHz spectral linewidth of rare-earth doped single-frequency fibre lasers make them unsuitable for coherent applications such as coherent LIDAR. Single-frequency DFB or DBR fibre lasers include fibre lasers comprising ytterbium (Yb) and/or erbium (Er) rare earth dopants with emission in the 0.98 μm to 120 μm range or the 1.52 μm to 1.62 μm range respectively, i.e. wavelength ranges below that of interest.

U.S. Pat. No. 6,151,429 deals with optical waveguides having asymmetric polarization, and single polarization waveguide lasers based on such waveguides and comprising rare earth dopant ions and distributed feed back or distributed Bragg reflector elements, the reflective elements being e.g. incorporated into the waveguide by a phase mask technique.

Hernandez-Cordero et al. (IEEE Photonics Technology Letters, Vol. 10, No. 7, Jul. 1998, p. 941-943) describe single— and dual-polarization Er/Yb-doped low-birefringence fibre lasers being tuneable around 1552 nm. The reflective elements are constituted by a broad-band bulk mirror and a fibre Bragg grating mirror embedded in a highly birefringent fibre, respectively.

U.S. Pat. No. 5,561,675 describes a fibre laser comprising a photo induced Bragg grating at each end of a birefringent optical fibre, enabling a separation of the two polarization modes.

Even though the constructions described in prior art have achieved some degree of success and/or acceptance in their respective fields of application, they still have certain drawbacks which may prevent their widespread use. Thus there is a need to improve known waveguide lasers exhibiting at least one of the following disadvantages of: Complexity, manufacturing cost, difficult to produce, lifetime, insufficient stability/maintenance, low efficiency, large size, high noise, low operating temperature, bad fibre compatibility, broad spectral line width, narrow tuning range, broad transverse mode profile.

### DISCLOSURE OF INVENTION

It is an object of the present invention to provide a relatively simple, compact and economic laser for single-frequency operation in the wavelength range of 1.7 μm to 2.2 μm.

It is Another Object to Provide a Method of Producing such a Laser.

It is still another object to provide use of such a laser; in particular for use in applications including spectroscopy, eye-safe optical sensing, and LIDAR. Further examples include urban pollution monitoring; chemical process control; hazardous environment monitoring; atmospheric research; combustion research and development; automotive exhaust monitoring; volcanic activity monitoring; carbon cycle research; windshear; and wind speed.

An Optical Waveguide Laser

In an aspect of the present invention an object of the invention is fulfilled by providing an optical waveguide laser comprising an optical waveguide for propagating light along a longitudinal axis of the waveguide and adapted for receiving pump light for axial propagation therein, the optical waveguide laser comprising a resonator arrangement, the resonator arrangement comprising

a) an active region formed over a length of the optical waveguide, the active region comprising an excitable material emitting light in response to stimulation by pump light thereby defining an optical gain profile; the excitable material comprises Tm;

b) a frequency discriminating feedback element adapted to select a single longitudinal lasing mode by coordination with the frequency response of the optical gain of the excitable material; and

c) a polarisation asymmetry element adapted for selecting a single polarisation mode of a given longitudinal mode by selectively suppressing propagation of the other polarisation mode of said longitudinal mode;

whereby an optical waveguide laser exhibiting single-frequency lasing in the wavelength band between 1.7 micron and 2.2 micron with a relatively compact and simple laser construction can be obtained, and which optical waveguide laser can be used in a range of applications, e.g. including portable and even handheld applications.

In a preferred embodiment of the invention, the host material of the optical waveguide is glass. Alternatively the host material may be a polymer material.

In an embodiment of the invention, the optical waveguide laser is implemented as ring-laser, preferably as a planar waveguide ring-laser.

In an embodiment of the invention, the optical waveguide comprises a core region and a cladding region wherein thulium (Tm) is present in the core region and/or said cladding region of said active region in concentrations of above 500 ppm wt., such as above 900 ppm wt., such as above 2000 ppm wt. A relatively higher concentration enables a relatively shorter primary laser cavity (cf. definition below), which facilitates the provision of single longitudinal mode operation. The concentration of the active rare earth ions (here typically Tm³⁺, optionally together with other rare earth ions) is limited by quenching effects due to the limited solubility of the ion(s) in the glass host. In silica glass, for example, the solubility can be increased by the addition of aluminium (Al), e.g. in an approximate 1:10 ratio of rare earth ion to aluminium.

In the present context, a ‘primary laser cavity’ is defined as comprising an active region, a frequency discriminating element and optionally a polarisation asymmetry element, and that the length of the primary laser cavity is taken to be the spatial extent in a longitudinal direction of the waveguide of the active region including the frequency discriminating element or elements. It is to be understood that an external feedback element (e.g. a polarisation asymmetric feedback element) which is not involved in selecting the single longitudinal mode is not considered a part of the primary laser cavity.

In an embodiment of the invention, the length of the primary laser cavity is smaller than 10 cm, such as smaller than 5 cm, such as smaller than 2 cm. Provided that sufficient gain is available, a shorter primary laser cavity results in larger longitudinal mode spacing and thereby facilitates single longitudinal mode selection.

When the optical waveguide is an optical fibre comprising a core region surrounded by a cladding region, it is ensured that a fibre compatible laser output and input pump delivery is enabled. Further, an excellent Gaussian transverse mode profile can be obtained. Further, it can provide an easy to produce laser based on well proven technologies, whereby a simple, maintenance free end product can be obtained.

In an embodiment of the invention, the optical fibre is a single-clad optical fibre. In an embodiment of the invention the core region has a higher refractive index (optionally averaged over its cross sectional area) than the cladding region.

When the cladding region comprises first and second cladding regions, it is ensured that one of the cladding regions may be customized to perform a specific function (e.g. serve as pump medium, or contain a frequency discriminating element, or a polarisation asymmetry).

In an embodiment of the invention, the optical waveguide is a dual-clad optical fibre. In an embodiment of the invention, the optical waveguide comprises more than two cladding regions.

In an embodiment of the invention, the core and/or at least one of the cladding region(s) comprise micro-structural elements (e.g. voids or fluid or solid elements) extending in the longitudinal direction of the fibre. This has the advantage of opening a range of design functionalities.

When the optical waveguide is a planar optical waveguide, it is ensured that a combination of the laser arrangement with other functional components such as wavelength division multiplexers (WDM), pump source, filtering components (e.g. an AWG), polarizer, etc. on one chip is enabled. Thereby a compact solution, e.g. comprising multiple laser sources such as is needed in DIAL-LIDAR systems or WDM-systems, can be obtained.

In an embodiment of the invention, the planar optical waveguide is formed on a substrate whereon a first cladding layer is grown, a core region is formed on the first cladding layer and a second cladding layer covering the core region and parts of the first cladding layer is formed thereon. In an embodiment of the invention the substrate is a silicon substrate and the core region and/or cladding layers comprise silica. Various relevant aspects of the silica-on-silicon technology are e.g. discussed in M. Kawachi, “Silica waveguide on silicon and their application to integrated-optic components”, Opt. Quant. Electr. 22 (1990) 391-416.

When the core and/or cladding region(s) comprise silica, it is ensured that the laser is compatible with standard silica fibres, and providing a large flexibility regarding production technology and experience, reliability, etc. Thulium doped fibre lasers are e.g. discussed in “Rare Earth Doped Fibre Lasers and Amplifiers”, 2^{nd} edition, 2001, ed. by Michel J. F. Digonnet, Marcel Dekker, chapter 2.4 and 3.8, referred to hereinafter as [Digonnet], which is incorporated herein by reference. Alternatively, other host materials may be used to extend the usable wavelength range and increase the lifetime of the excited state(s) of the active ions by using a glass host with a lower phonon energy, e.g. fluoride (e.g. fluorozirconate), tellurite, phosphate or chalcogenide based glasses (cf. e.g. section 2.4 in [Digonnet]).

In an embodiment of the invention, the core and/or cladding regions comprise at least one refractive index modifying dopants for controlling the refractive index profile of the region(s) in question.

When said core and/or cladding regions comprise at least one refractive index modifying dopants, said dopants being selected among the group of elements consisting of boron (B), nitrogen (N), fluorine (F), aluminum (Al), phosphorus (P), titanium (Ti), germanium (Ge), and tin (Sn), it is ensured that a specific refractive index profile may conveniently be designed under given waveguide requirements, including optimizing the glass host for the gain medium as well as the waveguiding and photosensitivity properties.

In an embodiment of the invention, the core and/or cladding regions comprise at least one photosensitive dopant for modifying the refractive index profile of the region(s) in question by exposure to light.

When said core and/or cladding regions comprise at least one photosensitive dopants, said dopants being selected among the group of elements consisting of Ge, B, N, Sn, it is ensured that the refractive index of the waveguide may be conveniently modified, e.g. over a part of its length to introduce a frequency selective element, such as a Bragg grating (cf. e.g. U.S. Pat. No. 6,151,429, FIG. 5 and the corresponding discussion). In an embodiment of the invention, the optical waveguide is silica-based and the guiding region or regions of the waveguide contain(s) germanium. Ge and B may preferably be used together.

In an embodiment of the invention, the waveguide comprises an intermediate region between the core and cladding regions. In an embodiment of the invention, photosensitive dopant(s) is/are located in said intermediate region surrounding the core region. In embodiments of the invention, the refractive index of the intermediate region is matched to either the core or the cladding region.

In an embodiment of the invention, a frequency discriminating feedback element in the form of a Bragg grating is written in the photosensitive intermediate region. In an embodiment of the invention, the refractive index profiles of the core, intermediate and cladding regions are arranged to provide a mode overlap with the intermediate region of a predetermined magnitude (at a desired wavelength λ) to achieve that the light propagated is reflected by the Bragg grating written in the intermediate region. Preferably the magnitude of the overlap is above 5%, such as above 10%, such as above 15%.

When said core and/or cladding regions further comprise at least one excitable materials, said excitable materials preferably being selected among the group of elements consisting of holmium (Ho), erbium (Er), ytterbium (Yb), samarium (Sm), neodymium (Nd) and praseodymium (Pr), it may be possible to increase the pump efficiency at a given pump wavelength. Further, other pump wavelengths can be enabled, thereby utilizing proven semiconductor laser sources around e.g. 920 nm, 980 nm and 1480 nm. Preferably, the excitable materials are comprised in the core region of the waveguide. Alternatively, excitable materials may be comprised in the core and/or in at least one intermediate regions. Alternatively to the mentioned rare earth elements, other elements from the rare earth group may be included.

When said pump light source is a semiconductor diode solid state laser or a semiconductor diode pumped fibre laser, it is ensured that a compact, economic, reliable and flexible solution can be achieved. Alternatively, the pump light source may be provided by another type of laser, e.g. a Ti:Sapphire or a Nd:YAG laser. In a preferred embodiment, the pump light source is fibre pigtailed for easy and robust coupling to an optical fibre laser.

When said polarisation asymmetry element is implemented by adapting said resonator arrangement to be birefringent, it can be obtained that the phase shift in a DBR or DFB structure is different for the two polarisation modes, whereby one of them is favoured. The degree of birefringence of an optical waveguide is defined by the difference between the effective mode indices in the two primary polarisation states. In an embodiment of the invention, the birefringence is larger than 10⁻⁶, such as larger than 10⁻⁵, such as larger than 10⁻⁴.

In an embodiment of the invention, the optical waveguide has a relatively low inherent birefringence, such as a birefringence below 10⁻⁴, such as below 10⁻⁵ such as below 10⁻⁶. In a particular embodiment, the optical waveguide has an inherent birefringence in the range from 10⁻⁷ to 10⁻⁵. By the term ‘inherent birefringence of the optical waveguide’ is in the present context meant the birefringence of the waveguide ‘as produced’.

In an embodiment of the invention, a polarisation asymmetry element is implemented outside the primary cavity of the laser, e.g. a polarisation dependent reflection from a Bragg grating in a birefringent optical waveguide (e.g. optically coupled to the primary laser cavity by fusion splicing).

When the polarisation asymmetry element is implemented by adapting the resonator arrangement to provide polarisation dependent optical feedback, it is achieved that one polarisation mode can be favoured.

When said polarisation asymmetry element is implemented by adapting said resonator arrangement—such as said optical waveguide—to provide polarisation dependent optical loss, one polarisation mode can be favoured. In an embodiment of the invention, the polarisation dependent optical loss is introduced into at least a part of the optical waveguide by the introduction of photosensitive materials or by the design of the refractive index profile of the optical waveguide.

In an embodiment of the invention, the polarisation asymmetry is introduced into at least a part of the optical waveguide comprising photosensitive dopant material after exposing said part of the length of the optical waveguide to light in a particular wavelength range (e.g. UV-light in the range 190-360 nm) for a predefined amount of time. Thereby different index profiles are introduced for two orthogonal polarisation states of the optical waveguide and one polarisation mode can be favoured.

In a preferred embodiment, said frequency discriminating feedback element comprises a Bragg grating. This represents a proven technology for providing stable frequency selective feedback in optical waveguides. By adapting the bandwidth of the Bragg grating to the mode spacing of the longitudinal modes of the resonator arrangement, single-longitudinal mode operation can be enabled.

Active silica waveguides doped with active dopant elements including thulium and based on Bragg gratings can provide single-frequency laser operation with narrow line width, e.g. in the kilohertz range, simple designs and direct compatibility with optical fibres, e.g. the so-called optical fibre distributed feedback (DFB) or distributed Bragg reflector (DBR) lasers.

When said frequency discriminating feedback element being located in said active region of the optical waveguide in the form of a Bragg grating with an intermediate phase shift thereby implementing a DFB resonator arrangement, it is ensured that a compact and stable laser resonator with low phase noise is provided.

The Bragg grating with a phase shift may e.g. be provided by illuminating said part of the optical waveguide (appropriately provided with at least one photosensitive dopants, e.g. Ge) using a phase mask technique as disclosed in U.S. Pat. No. 6,154,129, which is incorporated herein by reference.

When said frequency discriminating feedback element is implemented as two separated Bragg gratings, thereby implementing a DBR resonator arrangement, it is ensured that a compact and stable laser resonator with low phase noise is provided.

An Article Comprising an Optical Waveguide Laser

In an aspect of the present invention, an article comprising an optical waveguide laser as defined above in the section ‘An optical waveguide laser’ is furthermore provided.

With a thulium fibre laser small, rugged and eye-safe systems can be built due to the fact that it is all fibre coupled. One of the unique features with a single-frequency Tm-doped waveguide laser is its excellent phase noise properties which enable long coherence and thus high resolution and accurate measurements. Further, the wavelength region of a Tm-based optical waveguide laser is beneficial from an eye-safety point of view, thereby reducing the need for excessive safety precautions.

Thulium doped SiO₂ fibre lasers have a broad emission band with a potential for lasers covering the 1.7 to 2.2 μm band depending on the glass host composition. With the low phase noise, narrow spectral line width and wavelength selectability (and tunability), it is a strong candidate for building spectroscopy systems, e.g. for bio-medical applications, industrial process control applications, urban pollution monitoring applications, etc.

In embodiments of the invention such an article constitutes or forms part of laser systems for specific applications, e.g.
tunable/adaptable LIDAR systems in the 1.7 to 2.2 μm region having several advantages including:
   Eye safety that is opening up the usage in airborne and ground based LIDAR systems.
   As examples of LIDAR systems are Doppler and DIAL LIDAR systems (where DIAL is short for Differential Absorption Lidar) that with a thulium fibre laser enable the targeting of strong water absorption lines and thereby obtain better resolution to be used in measurement or mapping of distance, speed, rotation and chemical composition and concentration of a remote target where the target can be a clearly defined object, such as a vehicle, or a diffuse object such as a smoke plume or clouds. Such systems can advantageously be used for vortex detection on the ground and in the air, windshear detection, etc.
spectroscopy systems that with a fibre laser can target the exact wavelength required within the thulium band, thereby obtaining more accuracy in measurements. Further, specifically a Bragg grating based fibre laser facilitates simple wavelength tuning using tensile or compressive strain of the fibre grating. For tensile strain, a tuning range around 10 nm can be achieved, whereas a tuning range around 40 nm can be obtained for compressive strain.
other applications include:
   Counter measurement systems wherein targeting of the exact wavelength and thereby confusion of the attacking system is enabled.
   Systems that can detect emission from rockets or other fuelled products.
   Metrology systems, mapmaking systems, systems used for cargo drops, hand borne systems (due to the small form factor), wind speed sensing systems for windmills.

Examples of systems using single frequency laser spectroscopy are described by Raman U. Martinelli et al. in “Tunable single-frequency III-V semiconductor diode lasers with wavelengths from 0.76 to 2.7 μm”, Proceedings of SPIE, Vol. 2834, pp. 2-16, which is incorporated herein by reference.

In an embodiment of the invention, an article according to the invention comprises detector optics and electronics for signal processing, the article fully or partially forming a LIDAR system. Among the advantages of using an optical waveguide laser according to the invention in a LIDAR-system is the combination of eye-safety, wavelength selectability, narrow spectral line width, high signal-to-noise ratio, and optionally fibre coupling.

In an embodiment of the invention, an article according the invention comprises means for passage of laser light through a sample under investigation, detection optics and electronics for data reduction wherein, the article fully or partially forming a spectroscopic system. Among the advantages of using an optical waveguide laser according to the invention in a spectroscopy-system is the combination of wavelength selectability, relatively low prototyping costs, simple wavelength tuning and relatively wide tuning range.

In an embodiment of the invention, an article according to the invention comprises means for passage of laser light through a gas, the spectroscopic system being adapted for trace gas detection.

In a particular embodiment, an article according to the invention comprises a device for a nonlinear optical mixing process, such as frequency mixing and parametric amplification. The nonlinear device can e.g. be an optical fibre or a special crystal, such as periodically-poled Lithium Niobate (PPNL), periodically-poled Potassium Titanyl Phosphate (PP-KTP) or orientation-patterned Gallium Arsenide (OP-GaAs). The nonlinear process may e.g. used for generating a new wavelength, such as wavelengths above 2100 nm or below 1100 nm.

Nonlinear mixing processes is e.g. described in “The Elements of Nonlinear Optics”, Paul N. Butcher and David Cotter, Cambridge University Press, 1990, ISBN 0 521 34183 3. Nonlinear mixing using a laser and a noninear crystal is e.g. described in “Optical parametric oscillation in quasi-phase-matched GaAs”, K. L. Vodopyanov et. al., Optics Letters, Vol. 29, No. 16, Aug. 15, 2004 and in “Development of a tunable mid-IR difference frequency laser source for highly sensitive airborne trace gas detection”, D. Richter et. al., Applied Physics B, vol. 75, pp. 281-288, 2002.

Use of an Optical Waveguide Laser

Use of an optical waveguide laser as defined above in the section ‘An optical waveguide laser’ is moreover provided by the present invention.

A Method of Manufacturing an Optical Waveguide Laser

In an aspect of the present invention, a method of manufacturing an optical waveguide laser is provided. The method comprising:

1) providing an optical waveguide for propagating light along a longitudinal axis of the waveguide;

2) adapting said optical waveguide for receiving pump light from a pump light source for axial propagation therein;

3) providing a resonator arrangement in said optical waveguide laser, the step comprising the following sub-steps

3.1) forming an active region over a length of said optical waveguide by providing the active region with an excitable material emitting light in response to stimulation by pump light thereby defining a gain profile; the excitable material comprises Tm;

3.2) providing a frequency discriminating feedback element, the frequency discriminating feedback element being adapted to select a single longitudinal lasing mode by coordination with the frequency response of the gain of the excitable material; and

3.3) providing a polarisation asymmetry by adapting said resonator arrangement for selecting a single polarisation mode of a given longitudinal mode by selectively suppressing propagation of the other polarisation mode of said longitudinal mode.

The method allowing production of an optical waveguide laser according to the invention which method is easy and cost effective.

In an embodiment of the invention, in step 3.1) Tm is provided in said active region in concentrations of above 500 ppm wt., such as above 900 ppm wt., such as above 2000 ppm wt. Techniques for fabricating optical waveguides, including the incorporation of dopants such as photosensitive materials or active rare earth ions in glass-based optical waveguides, include various deposition techniques, e.g. chemical vapour deposition (CVD), modified CVD (MCVD), plasma enhanced CVD (PECVD), etc. which are well known in the art of manufacturing optical fibres as well as planar optical waveguides. The fabrication and properties (including laser properties) of exemplary rare earth doped fibres (including Tm-doped fibres) are e.g. discussed in U.S. Pat. No. 6,151,429. Fabrication and properties of Tm-fibres and lasers are specifically discussed by Y. Kim et al. in “Fabrication of Tm2+/Tm3+co-doped silica fiber and its fluorescence characteristics”, paper WA6, OFC-2003, Atlanta and by A. Tropper et al. in “Thulium-doped silica fiber lasers”, Proceedings of SPIE, vol. 1373, Fiber laser sources and amplifiers II, 1990 and by T. Yamamoto et al. in “1.9 μm Tm-doped silica fibre laser pumped at 1.57 μm”, Elec. Lett., Vol. 30, No. 3, 3rd Feb. 1994 and by W. A. Clarkson et al. in “High-power cladding-pumped Tm-doped silica fiber laser with wavelength tuning from 1860 to 2090 nm”, Optics Letters, Vol. 27, No. 22, Nov. 15, 2002.

It should be emphasized that the term “comprises/comprising” when used in this specification is taken to specify the presence of stated features, integers, steps or components but does not preclude the presence or addition of at least one other stated features, integers, steps, components or groups thereof.

### BRIEF DESCRIPTION OF DRAWINGS

The invention will be explained more fully below in connection with a preferred embodiment and with reference to the drawings in which:

FIG. 1 shows a setup for a single-frequency thulium doped waveguide laser according to the invention,

FIG. 2 shows an energy level diagram of thulium in silica glass host according to the invention,

FIG. 3 shows the absorption spectrum of a thulium doped silica fibre,

FIG. 4 shows the emission spectrum of a thulium doped silica fibre,

FIG. 5 shows the transmission spectrum of an asymmetric DFB waveguide laser resonator; (A) x-polarisation transmission spectrum, (B) y-polarisation transmission spectrum,

FIG. 6 shows an example of a laser setup,

FIG. 7 shows a spectrum of the example laser according to the invention,

FIG. 8 shows a scanning Fabry-Perot trace of the example laser according to the invention,

FIG. 9 shows a laser characteristic of the example laser according to the invention,

FIG. 10 shows a schematic LIDAR system according to the invention, and

FIG. 11 shows a schematic trace gas system according to the invention.

The figures are schematic and simplified for clarity, and they just show details which are essential to the understanding of the invention, while other details are left out. Throughout, the same reference numerals are used for identical or corresponding parts.

### MODE(S) FOR CARRYING OUT THE INVENTION

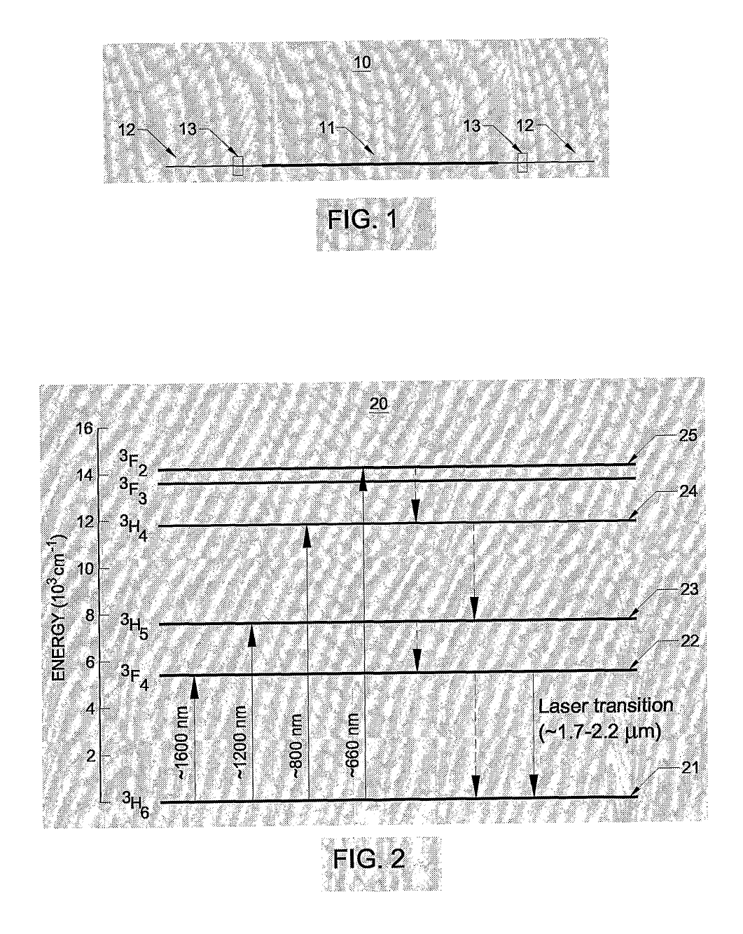

FIG. 1 shows a setup for a single-frequency thulium doped waveguide laser according to the invention.

The figure schematically depicts an exemplary single-frequency thulium doped fibre laser 10 according to the invention, wherein numerals 11-13 refer to, respectively, the thulium doped waveguide with optional imbedded laser resonator design 11, passive optical waveguide for guiding of optical pump light and waveguide laser output 12, and optional external feedback mechanism 13. Significantly, single-frequency lasing is obtained by using a wavelength selective, short laser resonator design to obtain lasing in a single longitudinal mode, in combination with a polarisation asymmetry to discriminate between the 2 orthogonal polarisation modes. The optional embedded laser resonator design in 11 is preferably a Bragg grating structure, such as a distributed feedback (DFB) or a distributed Bragg reflector (DBR) resonator. The optional external feedback mechanism 13 can be a Bragg grating serving as a DBR resonator or a feedback for self-injection locking of the laser. The optional external feedback mechanism 13 can alternatively come from a Fabry-Perot cavity. The polarisation asymmetry can typically be obtained by using UV exposure to create a polarisation dependent phase-shift or Bragg grating reflection in a DFB or DBR resonator, or by using a resonator with polarisation dependent loss or gain, or by using a polarisation dependent feedback mechanism, such as the reflection from a Bragg grating in a birefringent waveguide.

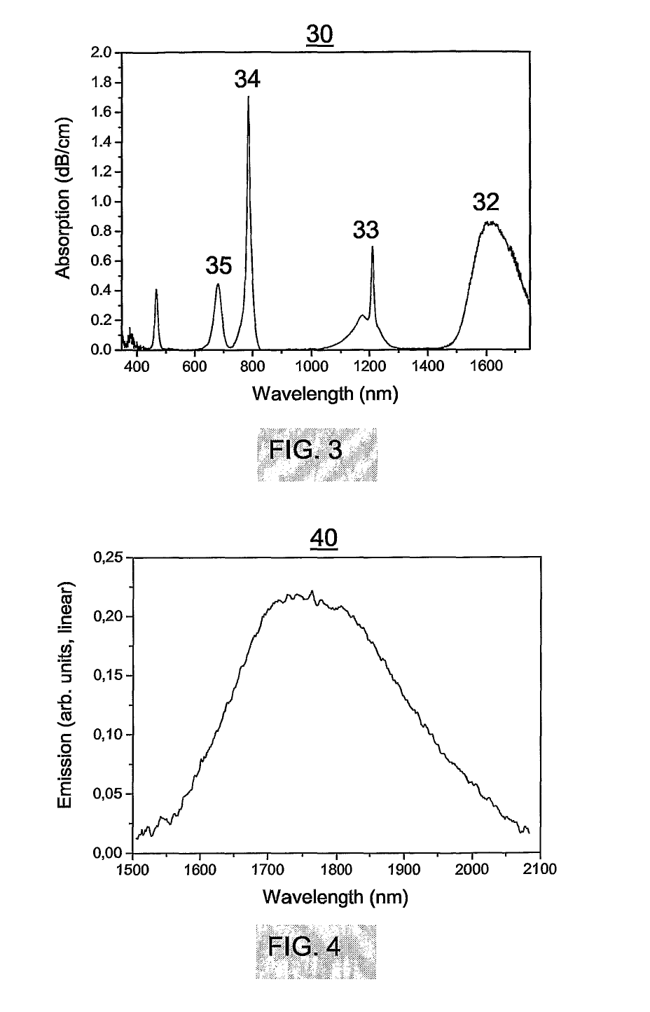

FIG. 2 shows an energy level diagram of thulium in a silica glass host according to the invention.

The figure shows the ground energy level and the first five excited states of thulium in a silica glass host 20, wherein the numerals 21-25 refer to, respectively, the ground state ³H₆ 21, the excited states ³F₄ 22, ³H₅ 23, ³H₄ 24 and ³F₂ 25. The laser transition originates from the upper laser level ³F₄ 22 to the ground level ³H₆ 21 with emission in the wavelength band between 1.7 μm and 2.2 μm. By optical pumping of the thulium ion with a wavelength around 1600 nm, 1200 nm 800 nm or 660 nm the thulium ion is excited, respectively, to the states ³F₄ 22, ³H₅ 23, ³H₄ 24 and ³F₂ 25, and will relax to the upper laser level 22 by phonon assisted transitions.

FIG. 3 shows the absorption spectrum of a thulium doped silica fibre.

The figure shows the absorption spectrum 30 of an example thulium doped germano-silicate optical fibre, wherein the numerals 32-35 refer to absorption from the ground energy state of the thulium ion to, respectively, the excited states ³F₄ 32, ³H₅ 33, ³H₄ 34 and ³F₂ 35. The spectrum is obtained using cutback technique between a 114 mm and a 42 mm long fibre sample, measuring the difference in transmission of a halogen lamp white-light source with an ANDO AQ-6315A optical spectrum analyser with 10 nm resolution bandwidth. The figure clearly illustrates the large bandwidth of the energy level transitions. Typical optical pump sources are Ti:sapphire laser or AlGaAs semiconductor laser diode for the ³H₄ level 34, Nd:YAG laser, Raman fibre laser or semiconductor diode pumped ytterbium doped fibre laser for the ³H₅ level 33 and Raman fibre laser or semiconductor diode pumped erbium doped fibre laser for the ³F₄ level 32. Codoping the thulium doped waveguide with other rare earth material such as ytterbium or erbium can enable other pump wavelength, e.g., the widely available 980 nm and 1480 nm pump diode used in telecommunication devices.

FIG. 4 shows the emission spectrum of a thulium doped silica fibre. The figure shows the emission spectrum 40 of the same thulium doped germano-silica optical fibre as used in FIG. 3. The spectrum is measured using the spontaneous emission from a 1 mm long fibre sample, which is pumped by a pulsed 785 nm AlGaAs semiconductor laser diode, transmitted through a Jobin-Yvon double-monochromator, and detected using a Hamamatsu G6122-03 InGaAs PIN detector module and a lock-in amplifier. The measurement is calibrated using a halogen lamp white-light source, which is assumed to be a blackbody radiator. The figure clearly illustrates the large emission bandwidth of the laser transition. The spectrum is very sensitive to the host glass composition, especially aluminium codoping will shift the emission spectrum towards longer wavelengths. Aluminium codoping will also increase the solubility of thulium in the silica glass and results in a longer lifetime of the upper laser level 22.

FIG. 5 shows the transmission spectrum of an asymmetric DFB waveguide laser resonator; (A) x-polarisation transmission spectrum, (B) y-polarisation transmission spectrum.

The figure illustrates the transmission spectrum 50 of an example single-frequency laser design according to the invention. This example is using a 50 mm long DFB resonator with a polarisation dependent 5 mm long distributed phase-shift in the center of the resonator. The two principal polarisation axes are denoted x and y, and for the x polarisation, the resonance 51 is located in the center of the Bragg grating spectrum with maximum feedback, whereas for the y polarisation, the resonance 52 is shifted away from the center and consequently has less feedback and therefore higher lasing threshold. If the discrimination between the x and y polarisations is large enough, then the laser will be single-frequency lasing in the x polarisation.

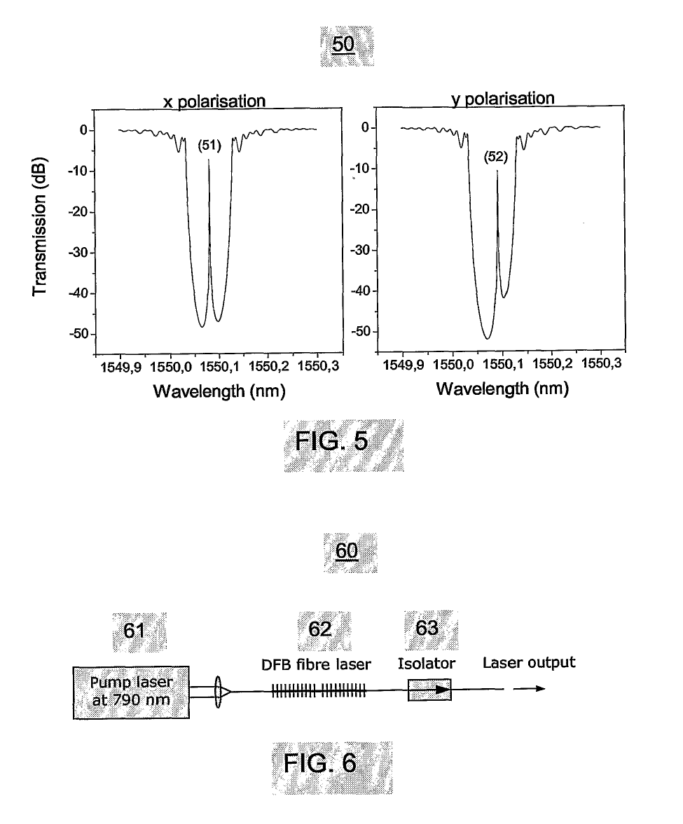

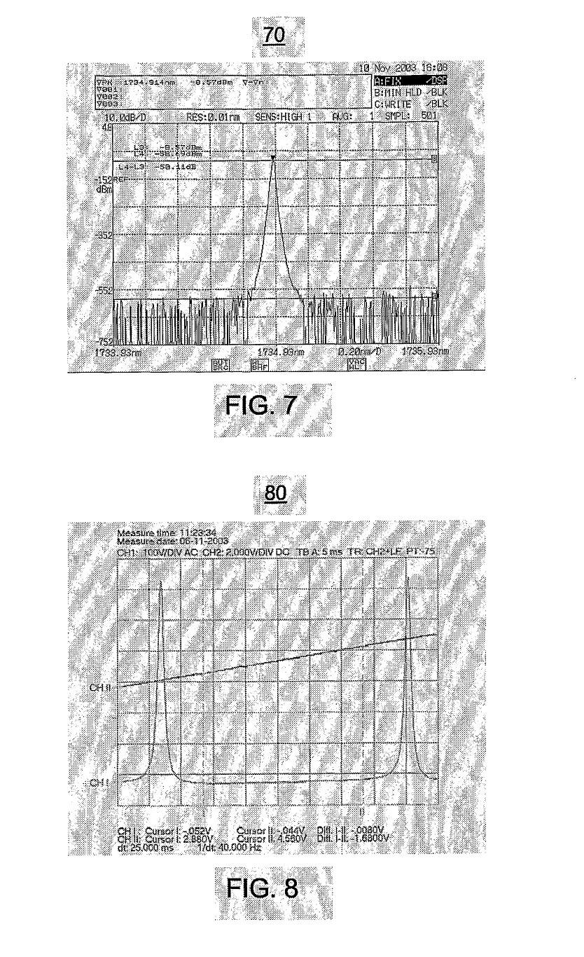

FIG. 6 shows an example laser setup.

The figure shows an example fibre laser 60 using the thulium doped fibre from FIG. 3 and FIG. 4, and the resonator design from FIG. 5. The numerals 61-63 refer to, respectively, a Ti:sapphire pump laser operating at 790 nm 61, a thulium doped DFB fibre laser 62 with birefringent phase-shift and an optical isolator 63 to protect the laser against back reflections.

FIG. 7 shows a spectrum of the example laser.

The figure shows the output spectrum 70 of the example laser from FIG. 6. The spectrum is measured on an ANDO AQ-6317B optical spectrum analyser and shows the lasing at 1735 nm. Measurement of the signal to amplified spontaneous noise (ASE) level is limited by the noise floor of the spectrum analyser, but is seen to be at least 50 dB.

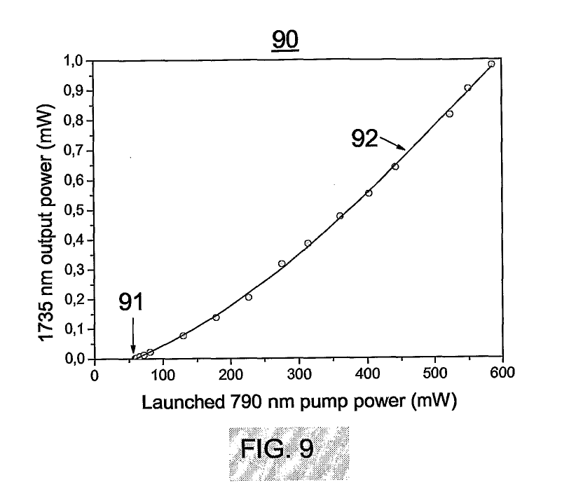

FIG. 8 shows a scanning Fabry-Perot trace 80 of the example laser. The single-frequency operation of the laser illustrated by FIG. 6 has been verified using Burleigh scanning Fabry-Perot interferometer with 2 GHz free spectral range and a finesse of 37 at 1735 nm.

The figure shows a scanning Fabry-Perot interferometer trace of the example laser from FIG. 6. The resolution of the interferometer is 54 MHz which is high enough to resolve the longitudinal modes and the polarisation modes. Additionally the single-frequency operation was verified by measuring the laser's intensity spectrum on a HP Lightwave Analyser, which showed no beating between lasing modes in the frequency interval from 100 kHz to 10 GHz. Investigation of the intensity spectrum revealed that the lasers relative intensity noise (RIN) peak is located at 460 kHz. By perturbing the laser cavity it could be provoked to oscillate in additional modes, which enabled measuring a polarisation mode spacing of 334 MHz and a longitudinal mode spacing of 4.665 GHz.

FIG. 9 shows a laser characteristic 90 of the example laser.

The figure shows the output power at 1735 nm of the example fibre laser from FIG. 6 versus the launched pump power at 790 nm. The laser has a threshold pump power 91 of 60 mW and a slope efficiency 92 of 0.24%.

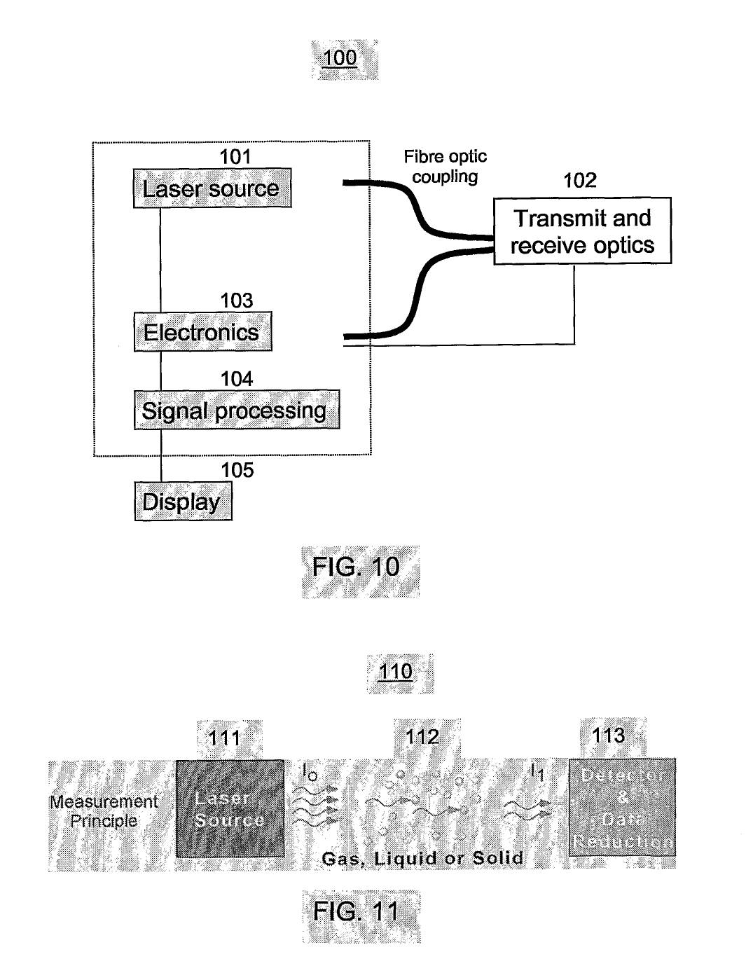

FIG. 10 shows a schematic LIDAR system according to the invention. LIDAR is a name used for “RADAR” systems utilizing electromagnetic radiation at optical frequencies. LIDAR's may be continuous-wave (CW) or pulsed, focused or collimated. CW LIDAR's are used when the signal may be integrated over long time periods and/or when the target is nearby. Focusing is mainly used with CW LIDAR's to obtain more sensitive measurements over a smaller span of ranges. Pulsed LIDAR's normally use much higher power levels during the laser pulse than can be maintained with a CW laser, producing higher signal-to-noise ratios for the collected radiation. Pulsed LIDAR's are usually chosen for long-range sensing and when long signal integration time is impractical.

The figure shows a schematic LIDAR system setup 100, wherein the numerals refer to, respectively, a laser source 101 according to the invention, optics for transmitting the laser light and receiving the returning light 102, electronics to control the laser and optics 103, signal processing equipment for analyzing the received data 104 and a display unit 105. The laser source 101 and the electronics 103 are fibre coupled to the optics 102, which ensures good stability. The laser 101 is preferably a single-frequency laser source with narrow spectral linewidth which enables coherent detection techniques with higher sensitivity than non-coherent LIDAR systems.

In an embodiment of the invention an optical fibre laser according to the invention is used in a system for measuring wind speed. The system uses the fact that laser radiation is scattered by atmospheric aerosols like dust, pollen, water vapour. A laser signal from a LIDAR system according to the invention (e.g. comprising a Tm-laser based on a DFB fibre resonator) is reflected from aerosols moving in the same direction and at the same speed as the wind. The reflected signal is received and analysed by signal processing.

FIG. 11 shows a schematic trace gas system according to the invention.

The figure shows a schematic setup for laser-absorption spectroscopy 110, wherein the numerals 111-113 refer to, respectively, the laser source 111 according to the invention, the gas, liquid or solid of interest 112 and the optical detector and signal processing 113. The laser source 111 should be wavelength tuneable to allow sweeping the laser frequency though the spectral feature of interest. When the laser frequency coincides with the absorption feature, the photo detector records a decrease in received power. If the material of interest 112 is a gas, it can e.g. be placed in a multipass gas cell to increase measurement sensitivity. Several gases have absorption lines that make them detectable with laser-absorption spectroscopy in the 1.7 μm to 2.2 μm wavelength band; among these are hydrogen chloride (HCl) at 1747 nm, methane (NH₄) at 1790 nm, nitrous oxide (N₂O) at 1953 nm, carbon dioxide (CO₂) at 1957 nm, hydrogen bromide (HBr) at 1960 nm, nitric oxide NO at 1810 nm, formaldehyde (H₂CO) at 1930 nm and several others. Tuneability may e.g. be implemented by introducing a controlled strain and/or temperature change to a fibre Bragg grating of the fibre laser.

The invention is defined by the features of the independent claim(s).

Preferred embodiments are defined in the dependent claims.

Some preferred embodiments have been shown in the foregoing, but it should be stressed that the invention is not limited to these, but may be embodied in other ways within the subject-matter defined in the following claims.

1. An optical waveguide laser comprising an optical waveguide for propagating light along a longitudinal axis of the waveguide and adapted for receiving pump light for axial propagation therein, the optical waveguide laser comprising a resonator arrangement, the resonator arrangement comprising:
a) an active region formed over a length of the optical waveguide, the active region comprising an excitable material emitting light in response to stimulation by pump light thereby defining an optical gain profile; the excitable material comprises Tm;
b) a frequency discriminating feedback element adapted to select a single longitudinal lasing mode by coordination with the frequency response of the optical gain of the excitable material; and
c) a polarisation asymmetry element adapted for selecting a single polarisation mode of a given longitudinal mode by selectively suppressing propagation of the other polarisation mode of said longitudinal mode.

2. An optical waveguide laser according to claim 1, wherein thulium is present said active region of said optical waveguide in concentrations of above 500 ppm wt., such as above 900 ppm wt., such as above 2000 ppm wt.

3. An optical waveguide laser according to any of claim 1, wherein the length of the primary laser cavity is smaller than 10 cm, such as smaller than 5 cm, such as smaller than 2 cm, the primary laser cavity being spatially limited by said active region and said frequency discriminating element.

4. An optical waveguide laser according to claim 1, wherein the optical waveguide is an optical fibre comprising a core region surrounded by a cladding region.

5. An optical waveguide laser according to claim 4, wherein the cladding region comprises first and second cladding regions.

6. An optical waveguide laser according to claim 1, wherein the optical waveguide is a planar optical waveguide.

7. An optical waveguide laser according to claim 4, wherein the core and/or cladding region(s) comprise silica.

8. An optical waveguide laser according to claim 4, wherein said core and/or cladding regions comprise at least one refractive index modifying dopants, said dopants being selected among the group of elements consisting of boron (B), nitrogen (N), fluorine (F), aluminum (Al), phosphorus (P), titanium (Ti), germanium (Ge), and tin (Sn).

9. An optical waveguide laser according claim 4, wherein said core and/or cladding regions comprise at least one photosensitive dopants, said dopants being selected among the group of elements consisting of Ge, B, N, Sn.

10. An optical waveguide laser according to claims 4, wherein said core and/or cladding regions further comprise at least one excitable materials, said excitable materials preferably being selected among the group of elements consisting of holmium (Ho), erbium (Er), ytterbium (Yb), samarium (Sm), neodymium (Nd) and praseodymium (Pr).

11. An optical waveguide laser according to claim 1, wherein said pump light source is a semiconductor diode solid state laser or a semiconductor diode pumped fibre laser.

12. An optical waveguide laser according to claim 1, wherein said polarisation asymmetry element is implemented by adapting said resonator arrangement to be birefringent.

13. An optical waveguide laser according to claim 1, wherein said polarisation asymmetry element is implemented by adapting said resonator arrangement to provide polarisation dependent optical feedback.

14. An optical waveguide laser according to claim 1, wherein said polarisation asymmetry element is implemented by adapting said resonator arrangement—such as said optical waveguide—to provide polarisation dependent optical loss.

15. An optical waveguide laser according to claim 1, wherein said frequency discriminating feedback element comprises a Bragg grating.

16. An optical waveguide laser according to claim 15, wherein said frequency discriminating feedback element is located in said active region of the optical waveguide in the form of a Bragg grating with an intermediate phase shift thereby implementing a DFB resonator arrangement.

17. An optical waveguide laser according to claim 15, wherein said frequency discriminating feedback element is implemented as two separated Bragg gratings, thereby implementing a DBR resonator arrangement.

18. An article comprising an optical waveguide laser according to claim 1.

19. An article according to claim 18 comprising detector optics and electronics for signal processing, the article fully or partially forming a LIDAR system.

20. An article according to claim 18 comprising means for passage of laser light through a sample under investigation, detection optics and electronics for data reduction wherein, the article fully or partially forming a spectroscopic system.

21. An article according to claim 20 comprising means for passage of laser light through a gas, the spectroscopic system being adapted for trace gas detection.

22. An article according to claim 18 comprising a device for a nonlinear optical mixing process, such as frequency mixing and parametric amplification.

23. Use of an optical waveguide laser according to claim 1.

24. Use according to claim 23 for nonlinear mixing, such as for frequency mixing and/or parametric amplification.

25. Use of an optical waveguide laser according to claim 1 in an article according to claim 18.

26. A method of manufacturing an optical waveguide laser, the method comprising:
1) providing an optical waveguide for propagating light along a longitudinal axis of the waveguide;
2) adapting said optical waveguide for receiving pump light from a pump light source for axial propagation therein;
3) providing a resonator arrangement in said optical waveguide laser, the step comprising the following sub-steps
3.1) forming an active region over a length of said optical waveguide by providing the active region with an excitable material emitting light in response to stimulation by pump light thereby defining a gain profile; the excitable material comprises Tm;
3.2) providing a frequency discriminating feedback element, the frequency discriminating feedback element being adapted to select a single longitudinal lasing mode by coordination with the frequency response of the gain of the excitable material; and
3.3) providing a polarisation asymmetry by adapting said resonator arrangement for selecting a single polarisation mode of a given longitudinal mode by selectively suppressing propagation of other polarisation modes of said longitudinal mode.

27. A method according to claim 26 wherein in step 3.1) Tm is present in said active region in concentrations of above 500 ppm wt., such as above 900 ppm wt., such as above 2000 ppm wt.
